(19) United States
(12) Patent Application Publication
(10) Pub. No.: US 2007/0034240 A1
(43) Pub. Date: Feb. 15, 2007

(54) Conveyor dishwasher with filtration of wash liquid

(76) Inventors: Dietrich Berner, Waldstetten (DE); Klaus Padtberg, Offenburg (DE)

Correspondence Address: THOMPSON HINE LLP, P.O Box 8801, DAYTON, OH, 45401-8801, US

(21) Appl. No.: 11/500,711

(22) Filed: Aug. 8, 2006

(30) Foreign Application Priority Data
Aug. 12, 2005 (DE) 10 2005 038 433.1

(51) Int. Cl. B08B 3/00

(52) U.S. Cl. 134/110; 134/56 D; 134/124; 134/198

(57) ABSTRACT

A conveyor dishwasher dishwasher includes a wash liquid filtration line having a microfiltration unit or an ultrafiltration unit for filtering sprayed wash liquid of a wash zone, whereby the filtered wash liquid is recirculated back to the wash zone.

### TECHNICAL FIELD

The invention relates to a conveyor dishwasher, typically in the form of a belt conveyor dishwasher or a rack conveyor dishwasher, and more particularly to such a dishwasher including a wash liquid filtration line.

### BACKGROUND

Conveyor dishwashers are disclosed for example in U.S. Pat. No. 3,789,860, U.S. Pat. No. 4,231,806, DE 196 44 438 C2 and DE 198 29 650 C2. The wash ware is conveyed by the conveyor device through one or more wash zones and a final rinse zone of the conveyor dishwasher. A liquid cascade is formed from one zone to the next, its direction of flow being opposite the direction of ware conveyance. If the liquid cascade is interrupted, the wash fluid in the wash tanks of the fluid cascade is no longer replenished by dilution with fresh water. Depending on the amount of food soils input into the wash liquid by the wash ware to be cleaned, this wash liquid may have a very high level of soiling, resulting in a reduced cleaning capacity.

Accordingly, it would be desirably to provide a conveyor dishwasher having a feature to account for wash liquid soiling.

### SUMMARY

In one aspect, a conveyor dishwasher contains at least one wash zone having wash nozzles for spraying wash liquid and equipped with a wash liquid recirculation line including a wash tank for collecting at least some sprayed wash liquid and a wash liquid supply line having a pump for supplying wash liquid from the wash tank to the wash nozzle. A final rinse zone has final rinse nozzles for spraying final rinse liquid. A conveyor device for conveying wash ware through the zones has a direction of conveyance from the wash zone to the final rinse zone. A wash liquid filtration line is provided for the wash zone for removal and then filtering of sprayed wash liquid out of the wash liquid recirculation line and for recirculating filtered wash liquid into the wash liquid recirculation line. The wash liquid filtration line may have a microfiltration device or an ultrafiltration device for filtering the sprayed wash liquid.

Using a microfiltration process or an ultrafiltration process actively counteracts and thereby prevents a high degree of soiling of the wash liquid. The burden of organic compounds in the wastewater of the conveyor dishwasher is also reduced by this measure. Due to this reduction in the amount of organic compounds in the wastewater, the cost of the wastewater can also be reduced.

A microfiltration device or an ultrafiltration device may be provided for multiple wash zones. The wash liquid present in the wash tank of the respective wash zone is preferably processed in a circulating system. For this processing of the wash water, fresh water may not be needed and instead only the soiling already present in the wash water may be removed from the wash liquid.

### BRIEF DESCRIPTION OF THE DRAWINGS

FIG. 1 is an embodiment of a conveyor dishwasher including a wash liquid filtration line.

### DETAILED DESCRIPTION

By way of example, the conveyor dishwasher may be a belt conveyor dishwasher of flight-type dishwasher in which the wash ware to be cleaned is conveyed through the machine by a conveyor belt, or it may be a rack-type conveyor ware washer in which the wash ware is conveyed through the machine in racks on a conveyor device. As used herein the term “conveyor device” refers to any mechanism, regardless of type or configuration, that moves wares through the zones described below.

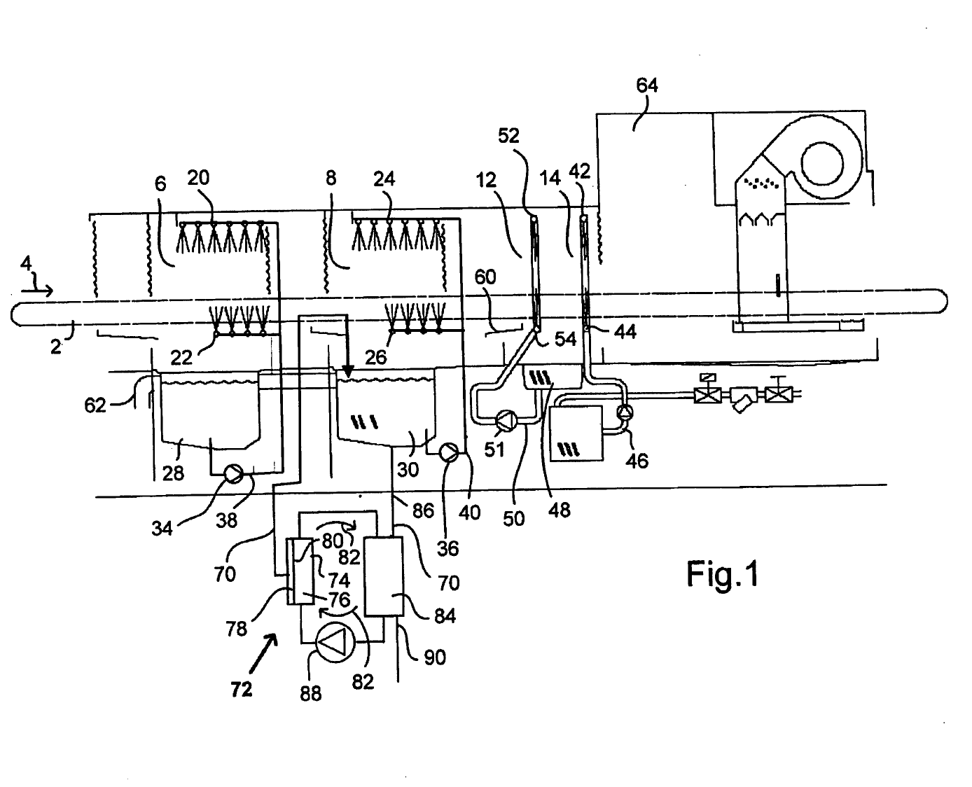

The conveyor dishwasher in FIG. 1 has a conveyor device 2, the direction of conveyance 4 of which is indicated by an arrow. The wash ware (not shown) may be of any type, e.g., plates, cups, glasses, utensils, trays, pots and pans.

The conveyor dishwasher has at least one wash zone, e.g., two (or more) wash zones 6 and 8, as shown in the drawings, arranged successively in the direction of conveyance 4 for washing the wash ware with wash liquid, and a final rinse zone 14 for the final rinse of the wash ware using final rinse liquid. The wash liquid may be water to which detergent is added by metered addition. The final rinse liquid may be fresh water with or without an added rinse aid.

Each wash zone 6 and 8 has both upper and lower wash nozzles 20, 22 and 24, 26 (typically associated with respective wash arms) for spraying wash liquid onto the wash ware inside the conveyor device 2. Each wash zone 6 and 8 is equipped with a wash tank 28 and 30, respectively, where the wash liquid sprayed by the wash nozzles 20, 22 and 24, 26 collects. The wash liquid is recirculated back from the wash tanks 28 and 30 to the wash nozzles 20, 22 and 24, 26 through a wash liquid feed line 38 or 40 by means of a pump 34 or 36, respectively. The wash liquid feed line 38 or 40 and the respective wash tank 28 or 30 form a wash liquid recirculation line 28/38 or 30/40, respectively. Each wash liquid recirculation line 28/38 and 30/40 together with the respective wash zone 6 or 8 and the respective wash nozzles 20, 22 or 24, 26 forms a wash liquid recirculation system.

Final rinse zone 14 is equipped with upper and lower final rinse nozzles 42 and 44 (typically associated with respective rinse arms) to which final rinse liquid can be fed through a final rinse liquid feed line 46. The sprayed final rinse liquid collects in a post-wash tank 48. This previously used final rinse liquid is conveyed through a post-wash liquid feed line 50 that contains a pump 51 to upper and lower post-wash nozzles 52 and 54. The post-wash liquid is thus previously used final rinse liquid. For this reason, the post-wash zone 12 may also be referred to as a pre-rinse zone and the post-wash liquid may be referred to as pre-rinse liquid. Post-wash tank 48 may thus also be referred to as a pre-rinse tank.

Some of the liquid sprayed by the post-wash spray nozzles 52 and 54 goes into the post-wash tank 48 and some of it goes into the last wash tank 30 over a baffle 60.

Wash tanks 28 and 30 and post-wash zone 48 form a liquid cascade system in which the liquid overflows from one tank to the next in a direction opposite the direction of movement 4 of the conveyor device 2. Liquid thus flows from post-wash tank 48 into the last wash tank 30 and from there into the next wash tank 28. The last wash tank 28 in this direction of flow, which is also the first wash tank in the direction of conveyance 4, is preferably provided with a drain 62 for dirty liquid.

A dryer 64 for drying the cleaned wash ware may be provided downstream from the final rinse zone 14 in the direction of conveyance 4.

As illustrated, a wash liquid filtration line 70 for removing and then filtering sprayed wash liquid out of the wash liquid recirculation line 30/40 of the respective wash zone 8 and for recycling filtered wash liquid into the same wash liquid recirculation line 30/40 is provided. While one liquid filtration line is shown for wash zone 8, all wash zones may include a similar liquid filtration arrangement. The wash liquid filtration line 70 contains a filtration unit 72, which may be a mcirofiltration unit or an ultrafiltration unit, for filtering the wash liquid. The main difference between microfiltration and ultrafiltration is the difference in pore sizes of the filter elements. Filtration through filter elements having a pore size <0.1 μm is called ultrafiltration, whereas filtration at pore sizes >0.1 μm to 100 μm is known as microfiltration.

The wash liquid filtration line 70 is preferably designed as a filtration circulation system into which a section (in the illustrated case the wash tank) of the wash liquid recirculation line 30/40 is integrated so that wash liquid flows out of section 30 and into the wash liquid filtration line 70 and after filtering the wash liquid, the filtered wash liquid flows back into this section 30. The section 30 may theoretically be any element of the wash liquid recirculation line 30/40 but is preferably the wash tank 30 of the respective wash zone 8.

According to a preferred embodiment, the microfiltration unit 72 or the ultrafiltration unit 72 has a cross-flow filter 74 for microfiltration or ultrafiltration of the sprayed wash liquid.

The cross-flow filter 74 contains at least one primary chamber 76 and at least one secondary chamber 78, the two chambers being separated from one another by at least one microfiltration element 80 or at least one ultrafiltration element 80. A section of the wash liquid filtration line 70 is formed by an internal recirculation system 82 for recirculating unfiltered wash liquid in which the primary chamber 76 is located and downstream from the primary chamber 76 there is a liquid collecting element 84. A feed section 86 of the wash liquid filtration line 70 also opens into this liquid collecting 84 for supplying sprayed wash liquid from the wash liquid recirculation line 30/40. The secondary chamber 78 serves to hold the portion of the wash liquid filtered through the at least one microfiltration element 80 or ultrafiltration element 80, said portion being a substream of the main stream of wash liquid flowing into the primary chamber 76. The internal recirculation system 82 has a pump 88 for supplying wash liquid out of the liquid collecting element 84 and into the primary chamber 76.

The liquid collecting element 84 is preferably a collecting tank for holding sprayed wash liquid from the wash liquid recirculation line 30/40 of the at least one wash zone and for holding wash liquid recycled from the primary chamber 76 back to the collecting tank 84. The collecting tank 84 is preferably designed for collecting food soils and is provided with a food soil trap 90 for removing dirt from the wash liquid.

It is to be clearly understood that the above description is intended by way of illustration and example only and is not intended to be taken by way of limitation, and that changes and modifications are possible. Accordingly, other embodiments are within the scope of the following claims.

1. A conveyor dishwasher, comprising:
at least one wash zone having wash nozzles for spraying wash liquid, the wash zone including a wash liquid recirculation line including a wash tank for collecting at least some sprayed wash liquid and a wash liquid supply line with a pump for supplying wash liquid from the wash tank to the wash nozzles;
a final rinse zone having final rinse nozzles for spraying final rinse liquid;
a conveyor device for conveying wares through the wash zone and the final rinse zone in a direction of conveyance from the wash zone to the final rinse zone,
characterized in that
the wash zone includes a wash liquid filtration line for removing and then filtering washed liquid out of the wash liquid recirculation line to produce filtered wash liquid, the wash liquid filtration line configured for returning filtered wash liquid back to the wash liquid recirculation line, the wash liquid filtration line including a filtration unit for filtering wash liquid, wherein the filtration unit comprises a microfiltration unit or an ultrafiltration unit.

2. The conveyor dishwasher according to claim 1, characterized in that
the wash liquid filtration line is arranged as a filtration circulation system into which is integrated a section of the wash liquid recirculation line so that wash liquid flows out of the section for filtering, and after the wash liquid has been filtered, the filtered wash liquid flows back into the section.

3. The conveyor dishwasher according to claim 2, characterized in that
the section is the wash tank.

4. The conveyor dishwasher according to claim 1, characterized in that
the filtration unit has at least one cross-flow filter for microfiltration or ultafiltration of the wash liquid.

5. The conveyor dishwasher according to claim 4, characterized in that
the cross-flow filter has at least one primary chamber and at least one secondary chamber that are separated from one another by at least one filtration element, a section of the wash liquid filtration line is formed by an internal recirculation system for recirculation of unfiltered wash liquid, the primary chamber is situated in the internal recirculation system and downstream from the primary chamber there is a liquid collecting element into which a feed section of the wash liquid filtration line also opens for supplying wash liquid out of the wash liquid recirculation line, and the at least one secondary chamber is arranged to accommodate a portion of the wash liquid that is filtered through the filtration element, said portion of the wash liquid being a substream of a main stream of the wash liquid flowing into the primary chamber.

6. The conveyor dishwasher according to claim 5, characterized in that
the liquid collecting element is a collecting tank for holding wash liquid from the wash liquid recirculation line of the wash zone and for holding wash liquid recirculated from the primary chamber.

7. The conveyor dishwasher according to claim 6, characterized in that
the collecting tank has a soil trap for removing soil from the wash liquid.

8. The conveyor dishwasher according to claim 1, characterized in that
the wash zone is a last wash zone in the direction of conveyance.

9. The conveyor dishwasher according to claim 1, characterized in that
the wash zone is a first wash zone in the direction of conveyance.

10. The conveyor dishwasher according to claim 1, characterized in that
the wash zone is one of at least two wash zones, and the other wash zone includes a corresponding wash liquid filtration line for removing and then filtering sprayed washed liquid out of its corresponding wash liquid recirculation line to produce filtered wash liquid that is returned back to its corresponding wash liquid recirculation line, the corresponding wash liquid filtration line including a corresponding filtration unit for filtering sprayed wash liquid, wherein the corresponding filtration unit comprises a microfiltration unit or an ultrafiltration unit.
